(19) United States
(12) Patent Application Publication
(10) Pub. No.: US 2025/0310333 A1
(43) Pub. Date: Oct. 2, 2025

(54) Fabric for Ease of Inter-Agency Communications

(71) Applicant: T-Mobile Innovations LLC, Overland Park, KS (US)

(72) Inventors: Dominic DECKYS, Denver, CO (US); Suryanarayana Murthy GORTY, Redmond, WA (US); James KAROLAK, Golden, CO (US); Sumeet PRAKASH, Issaquah, WA (US); Shelby SEWARD, North Bend, WA (US)

(21) Appl. No.: 18/619,140

(22) Filed: Mar. 27, 2024

(51) Int. Cl. H04L 9/40

(52) U.S. Cl. CPC H04L 63/10; H04L 63/0428; H04L 63/0823

(57) ABSTRACT

A method of providing inter-agency communications. The method comprises transmitting, by a fabric management application at a fabric hub of a communication fabric to a first agency, a certificate comprising tags associated with a channel accessibility of the first agency; receiving, by the fabric management application from a second agency, a request to create a channel, the request comprising an allow tag and/or a deny tag; publishing, by the fabric management application, the channel in a directory; transmitting, by the fabric management application to the first agency, in response to the publishing and a verification of the tags of the first agency against the allow tag and/or the deny tag, a notification of the channel; configuring, by the fabric management application, rules at a fabric junction of the communication fabric; and routing, by the fabric junction, based on the rules, communications between the first and second agencies in the channel.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A variety of emergencies, including terrorism, impending storms, school emergencies, natural disasters, and other catastrophes, can arise. Various agencies and/or organizations at local, state, and federal levels may be trained to respond to these emergency events. Personnel of an agency may communicate with each other using various modes of communication, for example, via the web, text messaging, phone systems, and/or other radio handheld systems. In some situations, it may be necessary to share data and/or voice information across multiple agencies to successfully respond to major incidents and large-scale emergencies. Accordingly, there is a need for inter-agency communications.

### SUMMARY

In an embodiment, a method implemented in a communication system to provide secured inter-agency communications with automatic channel publish notification is disclosed. The method comprises receiving, by a fabric management application at a computing system associated with a communication fabric, from a first agency, a connection request; transmitting, by the fabric management application to the first agency, based on the connection request, a certificate indicating the first agency is trusted by the communication fabric, wherein the certificate comprises one or more tags indicating one or more respective attributes associated with a channel accessibility of the first agency in the communication fabric; receiving, by the fabric management application from a second agency trusted by the communication fabric, a channel creation request to create a channel, the channel creation request comprising at least one of an allow tag indicating an attribute of an agency allowed to access the channel, or a deny tag indicating an attribute of an agency prohibited from accessing the channel; publishing, by the fabric management application, based on the channel creation request, the channel in a directory of agencies and associated channels; transmitting, by the fabric management application to the first agency, based on the publishing and a verification of the one or more tags associated with the first agency against the at least one of the allow tag or the deny tag of the channel, a notification of the published channel; configuring, by the fabric management application, based on the notification, rules at a fabric junction of the communication fabric, wherein the fabric junction comprises a plurality of routing engines, and wherein the rules are based at least in part on the one or more tags associated with the first agency and the at least one of the allow tag or the deny tag of the channel; and routing, by the fabric junction, based on the rules, communications between the first agency and the second agency in the channel.

In another embodiment, a method implemented in an inter-agency communication system is disclosed. The method comprises issuing, by a fabric management application at a computing system associated with a communication fabric, a plurality of certificates, each to one of a plurality of agencies trusted for inter-agency communications over the communication fabric, wherein each of the plurality of certificates comprises one or more tags indicating one or more respective attributes associated with a channel accessibility of a respective one of the plurality of agencies in the communication fabric; providing, by the fabric management application via a user interface at the computing system, a directory service listing the plurality of agencies and associated channels in a directory, wherein each channel of the channels is configured with at least one of an allow tag indicating an attribute of an agency allowed to access the respective channel; or a deny tag indicating an attribute of an agency prohibited from accessing the respective channel; filtering, by the fabric management application, the channels in the directory based on one or more tags associated with a first agency of the plurality of agencies in a respective one of the plurality of certificates and at least one of allow tags or deny tags of the channels; receiving, by the fabric management application from the first agency, based on the filtering, a channel subscription request to subscribe to a first channel of the channels, wherein the first channel is associated with a second agency of the plurality of agencies; configuring, by the fabric management application, based on the channel subscription request, a set of rules at a fabric junction of the communication fabric, wherein the fabric junction comprises a plurality of routing engines, and wherein the rules are based at least in part on at least one of an allow tag or a deny tag of the first channel, and the one or more tags associated with the first agency; routing, by the fabric junction, based on the rules, communications over the first channel between the first agency and the second agency.

In yet another embodiment, a method implemented in an inter-agency communication system is disclosed. The method comprises transmitting, by a management assistant application at a computing system of a first agency, to a fabric hub of an inter-agency communication fabric, a connection request; receiving, by the management assistant application from the fabric hub, based on the connection request, a certificate that establishes a trusted relationship between the first agency and the inter-agency communication fabric, wherein the certificate comprises one or more tags indicating one or more respective attributes associated with a channel accessibility of the first agency in the inter-agency communication fabric; receiving, by the management assistant application from the fabric hub, a notification of a channel associated with a second agency, wherein the notification is based on the one or more tags of the first agency, and at least one of an allow tag or a deny tag of the channel indicating respectively an attribute of an agency allowed to access the channel or an attribute of an agency prohibited from accessing the channel; transmitting, by the management assistant application to the fabric hub, based on the notification of the published channel, a subscription request to subscribe to the channel; and establishing, by the management assistant application with a fabric junction of the inter-agency communication fabric, a connection for communicating with the second agency over the channel.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a communication network according to an embodiment of the disclosure.

FIG. 2 is a signaling diagram of a secured inter-agency communication method according to an embodiment of the disclosure.

FIG. 3 illustrates an example certificate issued to a trusted agency according to an embodiment of the disclosure.

FIGS. 4A-4D are block diagrams illustrating a user interface for a directory service for secured inter-agency communications according to an embodiment of the disclosure.

FIG. 5 illustrates an example of a portion of a channel configuration according to an embodiment of the disclosure.

FIG. 6 illustrates an example of a portion of a channel configuration according to an embodiment of the disclosure.

FIG. 7 illustrates an example of a portion of a channel configuration according to an embodiment of the disclosure.

FIG. 8 illustrates an example of a portion of a channel configuration according to an embodiment of the disclosure.

FIG. 9 illustrates an example of a portion of a channel configuration according to an embodiment of the disclosure.

FIG. 10 is a block diagram of a fabric junction according to an embodiment of the disclosure.

FIG. 11 is a flow chart of a method according to an embodiment of the disclosure.

FIG. 12 is a flow chart of another method according to an embodiment of the disclosure.

FIG. 13 is a flow chart of yet another method according to an embodiment of the disclosure.

FIG. 14 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, the term “agency” may generally refer to an organization in a public sector or a private sector. In certain examples, an agency may have a mission to assist people before an anticipated impending emergency event, during and/or after an emergency event.

Today, agencies may each operate independently in terms of communication infrastructures. As discussed above, in some situations, it may be desirable for multiple agencies to communicate and coordinate with each other to respond to emergency events effectively. For instance, federal emergency management agency (FEMA) personnel may desire to communicate with local service personnel (e.g., emergency responders and city government officials in Tampa, Florida), for example, to coordinate search and/or rescue during and/or after an emergency event (e.g., a hurricane). However, different agencies may have different requirements (e.g., different security policies, different authentication processes, authorization processes, and/or verification processes) for communications. Furthermore, in some cases, the security policy of one agency may be incompatible with the security policy of the other agency with which communication is desired. As such, it may be difficult to establish a communication link or channel between different agencies. It may be particularly difficult when such a communication channel is to be established in an ad hoc manner within a short amount of time. For example, when an emergency occurs, FEMA may need to establish communication channels with local officials immediately, if not sooner. Therefore, a lack of software tools and/or infrastructures to allow agencies to establish channels quickly and securely for inter-agency communications creates various different technical problems.

The present disclosure provides a technical solution to the aforementioned technical problems in the technical field of inter-agency communications to allow different agencies to coordinate and communicate with each other in an effective manner by providing a secured inter-agency communication system, which may be referred to as an inter-agency communication fabric. For instance, the inter-agency communication system may include a fabric hub and a fabric junction. The fabric hub may be a computer system including server(s). The fabric junction may be a network of routing engines (e.g., including hardware and/or software configured to route communications across agencies). The fabric hub manages agency access to the inter-agency communication system and configures rules for the fabric junction to route runtime communications (e.g., text messaging, data, and/or voice) across agencies. In an embodiment, the fabric hub may address the differences in requirements among different agencies by utilizing certificates to establish a trusted relationship with each of the agencies at a setup time (e.g., prior to an emergency event in which a channel is needed for communication). To facilitate channel setup for secured inter-agency communications, the certificates may be embedded with tags (which may be referred to as channel accessibility tags) indicating attributes associated with channel accessibilities of respective agencies, where those tags may be verified by the fabric junction against channel access restriction tags for runtime communication. To that end, each channel in the inter-agency communication system may be tagged (attached or associated) with tags (the channel access restriction tags) to restrict channel access to intended agencies and prevent other unintended agencies from accessing the channel. For example, the tags for a certain channel may include two types of tags: allow tags and deny tags. The allow tags may indicate attributes of agencies that are allowed to communicate over the channel. The deny tags may indicate attributes of agencies that are prohibited from communicating over the channel. In this way, when an emergency occurs, a channel can be set up quickly (e.g., within a few seconds instead of a few minutes to tens of minutes) between agencies that are already trusted and verified by the inter-agency communication system. To facilitate cross-agency communications, the fabric hub may provide a directory service listing trusted agencies and associated channels. To further reduce the channel setup time, the fabric hub may coordinate with the trusted agencies to establish rules for automatic publishing of channels, automatic channel discovery, and/or automatic channel subscription.

As mentioned above, the inter-agency communication system may include the fabric hub and the fabric junction. A fabric management application may be executed on the fabric hub to manage agency access to the inter-agency communication system. The fabric management application may receive, from a first agency, a first connection request (e.g., including a first login credential of the first agency). In response, the fabric management application may transmit, to the first agency, a first certificate indicating the first agency is trusted for communications over the communication fabric. That is, the communication fabric has a trusted relationship with the first agency. The trusted relationship may be based on the first login credential and a verification of organization information associated with the first agency. For instance, the verification may include a verification of a location (e.g., a county, a city, a state, a region, etc.) of the first agency, an agency type (e.g., law enforcement, police departments, fire departments, search and rescue, medics, federal agency, state agency, local agency, etc.) of the first agency, and/or a name of the first agency (e.g., the actual name of the agency, such as FEMA, Tampa search and rescue, Tampa police, etc.). In an example, the verification of the organization information associated with the first agency may be in coordination with an external company or party that provides an automatic company verification process. The verification may be performed at a setup time (e.g., prior to an emergency event during) or a contractual time.

The first certificate may include tags indicating attributes associated with a channel accessibility of the first agency in the communication fabric. For example, the tags in the first certificate may include a first tag indicating a geographical area (e.g., a city, a state, a region, etc.) at which the first agency is located, a second tag indicating a mission or intended purpose (e.g., search and rescue, emergency response, medics, etc.) of the first agency, a third tag indicating an organization (e.g., law enforcement, police, fire department, swat, state patrol, FEMA, etc.) of the first agency, a fourth tag indicating security level information (e.g., federal clearance, state clearance, territory clearance, etc.) associated with the first agency, and/or a fifth tag indicating urgency level information (e.g., an urgency level, such as high, medium, or low, or at any suitable urgency level granularities) associated with the first agency. In an example, an emergency event and/or a responding agency associated with terrorism may have a high urgency level, an emergency event and/or a responding agency associated with a natural disaster (e.g., hurricane) may have a medium urgency level, and an emergency and/or a responding agency associated with a road accident may have a low urgency level. In an embodiment, the first certificate may further include information identifying the first agency, an Internet Assigned Numbers Authority (IANA) assigned Private Enterprise Number (PEN) identifying a provider of the fabric junction, and an association between the PEN and the tags associated with the first agency. In an example, the first certificate may be generated based on the International Telecommunications Union (ITU) X.509 standard. It should be appreciated that the first certificate may include various other information (e.g., version, publisher, issuer, signature, public key information, etc.).

In a similar way, the fabric management application may establish a trusted relationship with a second agency. For instance, the fabric management application may receive, from a second agency, a second connection request (e.g., including a second login credential of the second agency). In response, the fabric management application may transmit, to the second agency, a second certificate indicating the second agency is trusted for communications over the communication fabric based on the second login credential and a verification of organization information associated with the second agency. The second certificate may include tags similar to the tags of the aforementioned first certificate.

To facilitate inter-agency communication, the fabric management application may maintain a directory of agencies and associated channels so that other agencies can search and subscribe to the channels. In some examples, the fabric management application may provide a directory service via a user interface (UI) (e.g., a web browser interface) at the fabric hub. For instance, the fabric management application may receive, from the second agency, a channel creation request to create a channel for communications with another agency connected to the communication fabric. The channel creation request may include an allow tag and/or a deny tag. The allow tag may indicate an attribute of an agency allowed to access the channel. The deny tag may indicate an attribute of an agency prohibited from accessing the channel. Stated differently, an agency having a certificate including the allow tag may access the channel, whereas an agency having a certificate including the deny tag may not access the channel. In response to the channel creation request, the fabric management application may publish the channel in the directory.

In an embodiment, the allow tag and/or the deny tag may be associated with a geographical area, a mission, an organization, a security level, and/or an urgency level. The agency's tags (channel accessibility tags) and the channel's tags (channel access restriction tags) may include contextual information. As an example, a police swat team (e.g., an agency at Tampa, Florida) may be issued with a certificate including a list of tags: “swat”, “police”, “lawenforcement”, a state patrol team (e.g., another agency at Tampa Florida) may be issued with a certificate including a list of tags: “statepatrol”, “police”, and “lawenforcement”, and a channel (e.g., created by FEMA) may be tagged (attached or associated) with an allow tag indicating “swat” and a deny tag indicating “statepatrol”. Accordingly, the police swat team having the “swat” tag and no “statepatrol” tag may be allowed to access the channel for communication, whereas the state patrol team having the “statepatrol” tag may be denied access to the channel.

In an embodiment, the channel creation request may further include a textual name (e.g., a human-readable name) of the channel and a unique identifier of the channel (uniquely identifying the channel the communication fabric). In an embodiment, the channel creation request may further include a crypto password associated with an encryption for communications over the channel. In an example, the crypto password may be used (e.g., by the first agency) to derive an encryption key (e.g., a symmetric channel encryption key).

To further ease inter-agency communications, the fabric management application may provide a more efficient channel setup process by automatically notifying a relevant agency of a published channel (e.g., as an indication to request or invite the relevant agency to subscribe to the channel). For instance, the fabric management application may transmit, to the first agency, a notification of the published channel based on a verification of the first agency's tags in the first certificate against the channel's allow tag and/or deny tag. For instance, the verification may include a determination that at least one of the first agency's tags matches the channel's allow tag and/or a determination that none of the first agency's tags matches the channel's deny tag of the channel. In response to the notification, the fabric management application may receive, from the first agency, a subscription request to subscribe to the channel.

Based on the notification and/or the subscription request from the first agency, the fabric management application may configure a set of rules at the fabric junction. The set of rules may be based at least in part on the first agency's tags in the first certificate and the channel's allow tag and/or deny tag of the channel. The fabric junction may authenticate a connection with the second agency and a connection with the first agency based on the set of rules and route communications between the first agency and the second agency over the channel based on the authentication, thereby providing secured communications between the first agency and the second agency.

In an embodiment, to ease channel discovery, the fabric hub may filter the channels in the directory for a certain agency based on the agency's channel accessibility tags in a respective certificate and the allow tags and/or deny tags of the channels. For instance, the fabric management application may filter the channels in the directory (for the first agency) based on the first agency's tags in the first certificate and the allow tags and/or deny tags of the channel of the second agency.

The communication fabric may provide various enhanced functionalities to further ease and enrich inter-agency communications. For instance, the fabric junction may further include a text-to-speech engine and a speech-to-text engine to facilitate conversions between speech and text to allow personnel of an agency using voice to communicate with personnel of another agency using text, or vice versa. Additionally or alternatively, the fabric junction may include a translation engine to translate voice communications of agency personnel from one language to another language, thereby enabling personnel that would otherwise be unable to communicate effectively due to the different languages to communicate with each other. Additionally or alternatively, the fabric junction may include a machine learning (ML) engine (e.g., based on a generative artificial intelligence (AI) model)) to enable one agency to retrieve information from another agency easily and quickly. Additionally or alternatively, the fabric junction may include an archival engine to facilitate archiving of communications over certain channel(s).

According to another embodiment of the present disclosure, to assist automation of channel publishing, channel discovery, and/or channel subscription for cross-agency communications, an agency may include a management assistant application executed on a computer system of the agency. For instance, the management assistant application may automatically establish a connection with a fabric hub of an inter-agency communication system, automatically download a certificate from the fabric hub, automatically publish a channel based on an automatic channel publishing rule (e.g., related to an emergency event), automatically subscribe to a channel based on a notification of a published channel received from the fabric hub, and/or automatically configure a crypto password at system components and/or devices of personnel of the agency when a subscribed channel is encrypted. Such and other aspects will be described in more detail later herein.

Utilizing certificates as a uniform mechanism to establish trusted relationships between the inter-agency communication system and agencies can allow agencies having different security requirements and/or policies to connect to the inter-agency communication system for secured inter-agency communications. Establishing trusted relationships with agencies prior to an emergency can allow channels to be established (or “spin up”) quickly between agencies that are already trusted by the inter-agency communication system instead of wasting time to authenticate agencies and resolve differences in security policies at the time when a channel is needed for communication. Embedding channel accessibility tags in the agencies' certificates and configuring channels with allow and/or deny access tags can allow an agency to create a channel and restrict access to the channel to certain agencies (e.g., for security purposes). Providing a directory service listing trusted agencies and associated channels can allow agencies to discover peer agencies and/or associated channels quickly and easily. Automating channel publishing, channel discovery (e.g., via channel filtering at the directory), and channel subscription can further ease cross-agency communications and reduce channel setup time.

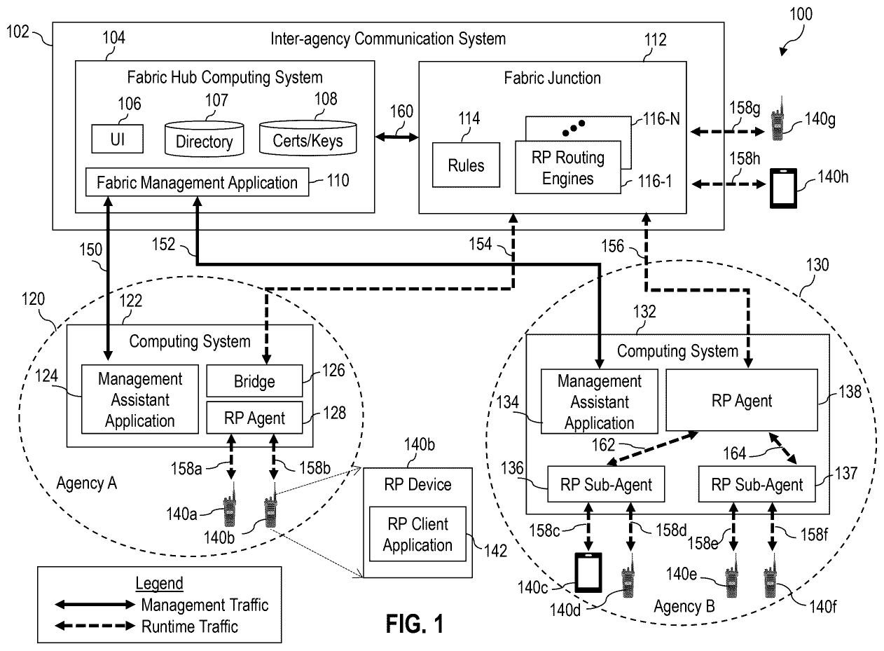

Turning now to FIG. 1, a network 100 is described. In an embodiment, the network 100 includes an inter-agency communication system 102, which may be referred to as a communication fabric, an agency A 120 and an agency B 130 communicatively coupled via the inter-agency communication system 102. Agency A 120 and agency B 130 may be any organizations, for example, responsible for responding to and/or handling emergency situations, such as terrorism, impending storms, school emergencies, natural disasters, and/or other catastrophes. In one example, one of agency A 120 or agency B 130 may be a local agency (e.g., a search and rescue team in Tampa, Florida), and the other one of agency A 120 or agency B 130 may be a federal agency (e.g., FEMA). In another example, both agency A 120 and agency B may be local agencies. In yet another example, both agency A 120 and agency B may be federal agencies. In FIG. 1, the solid line arrows may represent management traffic in a management plane of the network 100, and the dashed line arrows may represent runtime traffic (e.g., voice, text messaging, videos, photos, etc.) in a data plane of the network 100. In general, the management traffic and the runtime traffic may be communicated over one or more networks. The one or more networks may include public network(s), private network(s), or a combination thereof. The one or more networks may include the Internet, wireline network(s), wireless communication network(s), or a combination thereof.

The inter-agency communication system 102 may include a fabric hub computing system 104, which may be referred to as a fabric hub herein, and a fabric junction 112. Agency A 120 may include a computing system 122 and rally point (RP) devices 140a and 140b (e.g., client devices). The RP devices 140a and 140b may be used by personnel of agency A 120 for communications related to operations (e.g., search, rescue, medics, etc.) in response to an event of an emergency. The RP devices 140a and 140b may access and/or connect to the inter-agency communication system 102 via the computing system 122 of agency A 120 for communications with other agencies. Similarly, agency B 130 may include a computing system 132 communicatively coupled to RP devices 140c, 140d, 140e, and 140f. The RP devices 140c-140f may be used by personnel of agency B 130 for communications related to operations in response to an emergency. The RP devices 140c-140f may access and/or connect to the inter-agency communication system 102 via the computing system 132 of agency B 130 for communications with other agencies. As further shown in FIG. 1, the network 100 may further include RP devices 140g and 140h used by individuals (e.g., response or medic team members) connecting directly to the fabric junction 112 for communications with other personnel and/or other agencies. In general, the inter-agency communication system 102 may provide inter-agency communication to any suitable number of agencies (e.g., 2, 3, 4, 5, 6 or more) and associated RP devices 140 and/or directly communicate with any suitable number of RP devices 140 (e.g., 1, 2, 3, 4, 5, 6 or more). Further, each agency may include any suitable number of RP devices 140 (e.g., 1, 2, 3, 4, 5, 6, 7, 8, 8, 10 or more).

The RP devices 140a-140h may be collectively referred to as 140. In an embodiment, an RP device 140 may be a cell phone, a mobile phone, a smart phone, a personal digital assistant (PDA), an Internet of things (loT) device, a wearable computer, a headset computer, a laptop computer, a tablet computer, a notebook computer, embedded wireless modules, and/or other wirelessly equipped communication devices.

The fabric hub 104 may manage agency access (e.g., the management traffic 150 and 152) to the inter-agency communication system 102 and configure rules 114 at the fabric junction 112 for routing runtime communications (e.g., the runtime traffic 154, 156, 158g, and 158h) among agencies and/or personnel of agencies. As further shown in FIG. 1, the fabric hub 104 may include a UI 106, a directory 107, a certificates and keys repository 108, and a fabric management application 110. The fabric hub 104 may include one or more servers including memory and processor(s). The directory 107 and the certificates and keys repository 108 may be stored at the memory. The fabric management application 110 may include instructions stored at the memory of the fabric hub 104, which when executed by the processor(s), causes the fabric management application 110 to perform operations as discussed below. For instance, the fabric management application 110 may establish trusted connections with agency A 120 and agency B 130. As part of establishing the trusted connections, the fabric management application 110 may issue a certificate to each of agency A 120 and agency B 130. The issuing of the certificates may be based on a verification of at least one of a location (e.g., a county, a city, a state, a region, etc.), an agency type (e.g., law enforcement, police departments, fire departments, search and rescue, medics, federal agency, state agency, local agency, etc.), or a name of the respective agency A 120 or agency B 130 (e.g., the actual name of the agency, such as FEMA, Tampa search and rescue, Tampa police, etc.). That is, the verification verifies that an agency is who the agency claims to be. In an example, the verification of the organization information associated with agency A 120 and/or agency B 130 may be performed (e.g., at a setup time or contractual time) in coordination with an external company or party that provides an automatic company verification process.

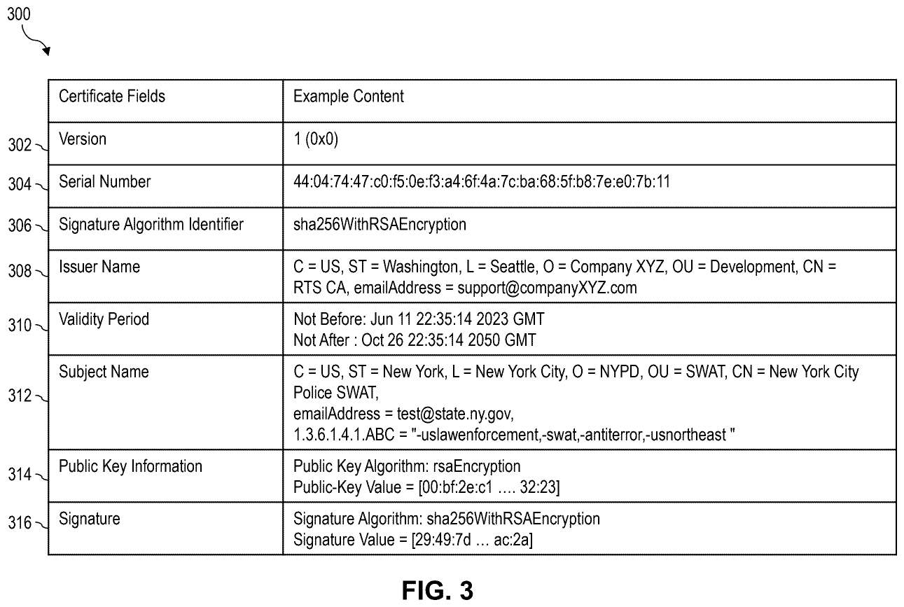

Each certificate may be embedded with tags indicating attributes associated with a channel accessibility of a respective agency (e.g., agency A 120 or agency B 130). The agency's channel accessibility attributes may be associated with a geographical area at which a respective agency is located, a mission or intended purpose (e.g., search and rescue, emergency response, medics, etc.) of the respective agency, an organization or organization unit (e.g., law enforcement, police, fire department, swat, state patrol, etc.) of the respective agency, security level information (e.g., federal clearance, state clearance, territory clearance, etc.) associated with the respective agency, and/or urgency level information (e.g., an urgency level, such as high, medium, or low, or at any suitable urgency level granularities) associated with the respective agency. In an example, the certificates may be ITU X.509 certificates and may include other information (e.g., version, publisher, issuer, signature, public key information, etc.) as will be discussed further below with reference to FIG. 3. In an example, the certificates and keys repository 108 may store the certificates and/or associated encryption and/or decryption keys of the agencies (e.g., agency A 120 and/or agency B 130).

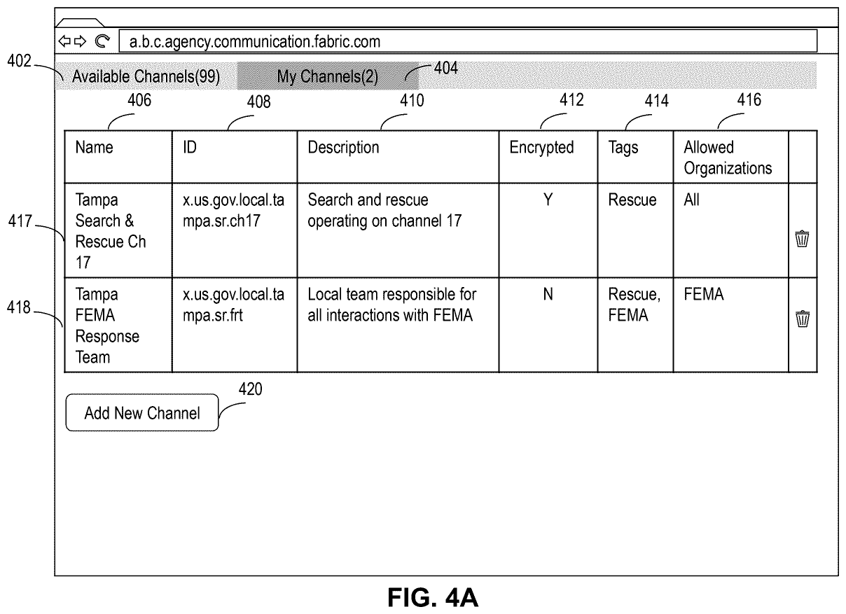

The fabric management application 110 may provide a directory service to facilitate agencies to search for channels shared by peer agencies for purposes of interoperability. For instance, the fabric management application 110 may create and maintain the directory 107 including a list of agencies and associated channels based on connections established with agency A 120 and agency B 130. The fabric management application 110 may facilitate channel creations, publishing of channels, channel discovery, and channel subscriptions by agency A 120 and agency B 130. The fabric management application 110 may present the directory to agency A 120 and/or agency B 130 via the UI 106. For instance, an administrator of agency A or an administrator of agency B 130 may interact with the UI 106. In an example, the UI 106 may be a web browser interface as will be discussed more fully below with reference to FIGS. 4A-4D.

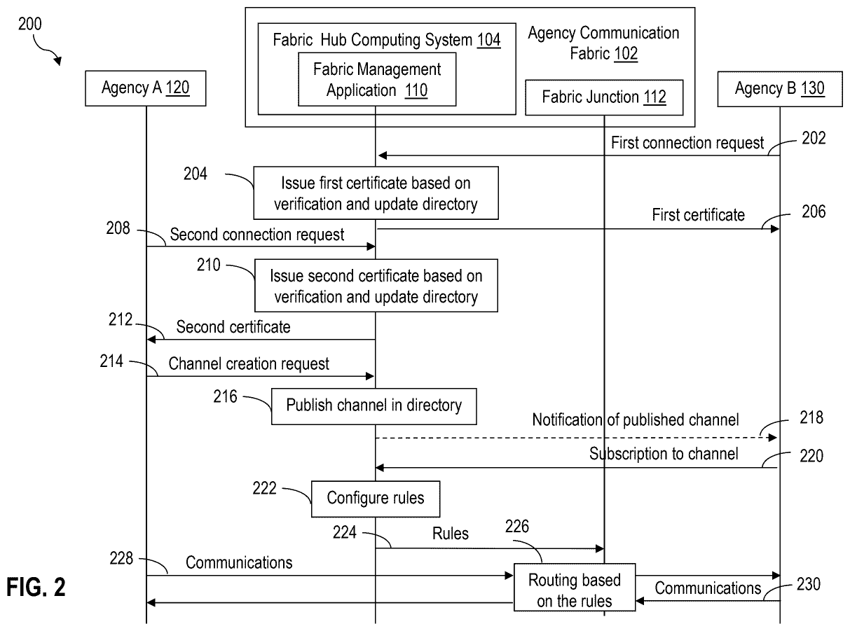

In the network 100, each channel may be tagged (or attached) with channel access restriction tags (e.g., an allow tag and/or deny tag) to restrict channel access to certain agencies. For instance, an allow tag may indicate an attribute of an agency allowed to access the channel. Conversely, a deny tag may indicate an attribute of an agency prohibited from accessing the channel. In an example, a channel of agency A 120 may be published in the directory 107 and agency B 130 may subscribe to the channel of agency A 120 based on a search in the directory 107, where the search may be based on a comparison of the channel accessibility tags of agency B 130 in the certificate issued to agency B 130 and the channel access restriction tags of the channel. In some examples, a channel may also be encrypted, for example, based on a crypto password. In an example, the crypto password may be used (e.g., by agency B 130) during a derivation of a symmetric encryption key. In an embodiment, the fabric management application 110 may further ease inter-agency communications by facilitating automatic publishing of channel, automatic channel discovery, and automatic channel subscriptions. Mechanisms for providing a directory service for inter-agency communications and automation related to channel setup will be discussed more fully below with reference to FIG. 2.

To facilitate secured communications (e.g., the runtime traffic 154 and 156) between agency A 120 and agency B 130, the fabric management application 110 may configure the rules 114 at the fabric junction 112. The configuration of the rules 114 may be communicated to the fabric junction 112 as shown by the management traffic 160. The rules 114 may include information associated with the certificate of agency A 120, the certificate of agency B 130, and the channel configuration (e.g., allow tag(s) and/or deny tag(s)) of the channel (created and owned by agency A 120). In this way, the fabric junction 112 may authenticate connections with agency A 120 and/or agency B 130 based on the rules 114 as will be discussed more fully with reference to FIG. 2.

As further shown in FIG. 1, the fabric junction 112 may include a plurality of RP routing engines 116 (individually shown as 116-1, . . . , 116-N). The RP routing engines 116 may include hardware and/or software configured to route communications (e.g., data and/or voice packets) between agency A 120 and agency B 130 over the channel based on the rules 114. In an example, the RP routing engines 116 may be packet routers. In general, the RP routing engines 116 may be configured in any suitable topology (e.g., a cluster or mesh topology, a spine-leaf topology, etc.).

As further shown in FIG. 1, the computing system 122 of agency A 120 may include a management assistant application 124, a bridge 126, and an RP agent 128. The computing system 122 may include one or more servers including memory and processor(s). Each of the management assistant application 124, the bridge 126, and the RP agent 128 may include instructions stored at the memory, which when executed by the processor(s), causes the respective component to perform operations as discussed below. In an embodiment, the RP agent 128 may establish a connection and communicate with the fabric junction 112 (shown by 154) and establish connections and communicate with the RP devices 140a and 140b (respectively shown by 158a and 158b). The bridge 126 may be optional. For instance, in one example, the bridge 126 may connect the RP agent 128 to the fabric junction 112. In another example, the RP agent 128 may communicate directly with the fabric junction 112. In general, the RP agent 128 may route inter-agency communications (e.g., the runtime traffic 154 and 158a) between the fabric junction 112 and the RP device 140a, route inter-agency communications (e.g., the runtime traffic 154 and 158b) between the fabric junction 112 and the RP device 140b, and/or route intra-agency communications (e.g., the runtime traffic 158a and 158b) between the RP devices 140a and 140b.

In an embodiment, each of the RP devices 140 may include an RP client application 142. For simplicity, FIG. 1 only illustrates the RP client application 142 for the RP device 140b. The client application 142 may include instructions stored at memory of the respective RP device 140, which when executed by processor(s) of the respective device 140, causes the processors to communicate (e.g., text messaging, voice calls, etc.) with other RP devices via respective RP agent 128 or 138 and/or RP sub-agent 136 or 137 as discussed above. In an embodiment, the RP agent 128 and the RP client application 142 may be substantially similar, for example, when a peer-to-peer communication protocol is used. In some examples, the runtime traffic 154, 158a, and 158b may be communicated over a transmission control protocol (TCP) layer and/or a user datagram protocol (UDP) layer. In some examples, the runtime traffic 154, 158a, and 158b may be communicated over transport layer security (TLS) connections in association with respective agency certificates and/or tags of respective channels.

In an embodiment, the management assistant application 124 may initiate a connection with the fabric hub 104 on behalf of agency A 120, download the certificate issued to agency A 120 from the fabric hub 104, save the downloaded certificate at the memory of the computing system 122, coordinate with the fabric hub 104 to automate publishing of channels, channel discovery, and/or channel subscription on behalf of agency A 120, obtain crypto passwords for respective channels from the fabric hub 104, and/or configure components (e.g., the bridge 126, the RP agent 128, and/or the RP devices 140a and 140b) of agency A 120 with the crypto passwords. In an embodiment, the computing system 122 of agency A 120 may include a management console for an administrator to perform similar operations as the management assistant application 124, but in a manual manner. For instance, the administrator may manually connect to the fabric hub 104, manually publish, search, and/or subscribe to channels, manually obtain crypto passwords for respective channels from the fabric hub 104, and/or manually configure components of agency A 120 with the crypto passwords. In some examples, the bridge 126 may operate as an interface between the fabric hub 104 and the management console. In general, agency A 120 may connect to the fabric hub 104 and publish, search, and/or subscribe to channels via a combination of automatic and manual mechanisms as will be discussed more fully below with reference to FIG. 2.

As further shown in FIG. 1, the computing system 132 of agency B 130 may include a management assistant application 134, an RP agent 138, and RP sub-agents 136 and 137. The computing system 132 may include one or more servers including memory and processor(s). Each of the management assistant application 134, the RP agent 138, and RP sub-agents 136, 137 may include instructions stored at the memory, which when executed by the processor(s), causes the respective component to perform operations as discussed below. In an embodiment, the RP agent 138 may establish a connection and communicate with the fabric junction 112 (shown by 156) and establish connections and communicate with RP sub-agents 136 and 137 (respectively shown by 162 and 164). The RP sub-agent 136 may establish connections and communicate with the RP devices 140c and 140d (respectively shown by 158c and 158d). Similarly, the RP sub-agent 137 may establish connections and communicate with the RP devices 140e and 140f (respectively shown by 158e and 158f). In general, the RP agent 138 may route inter-agency communications (e.g., the runtime traffic 156, 162 and 164) between the fabric junction 112 and the RP sub-agents 136 and 137. The RP sub-agent 136 may route inter-agency and intra-agency communications (e.g., the runtime traffic 162, 158c, and 158d) between the RP agent 138 and respective RP devices 140c and 140d. The RP sub-agent 136 may further route intra-agency communication between the RP devices 140c and 140d. In a similar way, the RP sub-agent 137 may route inter-agency and intra-agency communications (e.g., the runtime traffic 164, 158e, and 158f) between the RP agent 138 and respective RP devices 140e and 140f. The RP sub-agent 137 may further route intra-agency communication between the RP devices 140e and 140f.

In an example, for intra-agency communications, the RP sub-agent 136 may route communications between the RP devices 140c and 140d (e.g., in a southeast region), and the RP sub-agent 137 may route communications between the RP devices 140e and 140f (e.g., in a northeast region). The RP agent 138 may route communications between the RP sub-agents 136 and 137. As an example, the RP device 140c (in the southeast region) and the RP device 140e (in the northeast region) may communicate with each other via the RP sub-agent 136, the RP agent 138, and the RP sub-agent 137. In general, an agency may include any suitable number of RP sub-agents arranged in any suitable hierarchy to handle communications among RP devices of the agency.

In an embodiment, the RP agent 138, the RP sub-agents 136 and 137, and the RP client applications 142 at the RP devices 140-140f may be substantially similar, for example, when a peer-to-peer communication protocol is used. In some examples, the runtime communication 156, 162, 164, and 158c-158f may be communicated over a TCP layer and/or a UDP layer. In some examples, the runtime communication 156, 162, 164, and 158c-158f may be communicated over TLS connections in association with respective agency certificates and/or tags of respective channels.

In an embodiment, the management assistant application 134 of agency B 130 may perform substantially similar operations as the management assistant application 124 of agency B 130. For instance, the management assistant application 134 may initiate a connection with the fabric hub 104 on behalf of agency B 130, download the certificate issued to agency B 130 from the fabric hub 104, coordinate with the fabric hub 104 to automate publishing of channels, channel discovery, and/or channel subscription on behalf of agency B 130, obtain crypto passwords for respective channels from the fabric hub 104, and/or configure components of agency B 130 with the crypto passwords. In an embodiment, the computing system 132 of agency B 130 may include a management console for an administrator to manually perform substantially similar operations as the management assistant application 134, but in a manual manner. While not shown in FIG. 1, in some examples, the computing system 132 of the agency B 130 may also include a bridge similar to the bridge 126 in the computing system 122 of agency A 120.

FIG. 1 is merely an example of components of an inter-agency communication system, and variations are contemplated to be within the scope of the present disclosure. In embodiments, the inter-agency communication system may include other components not illustrated in FIG. 1. In embodiments, the inter-agency communication system may not include every component illustrated in FIG. 1. In embodiments, the components and connections may be implemented with different connections than those illustrated in FIG. 1. Such and other embodiments are contemplated to be within the scope of the present disclosure.

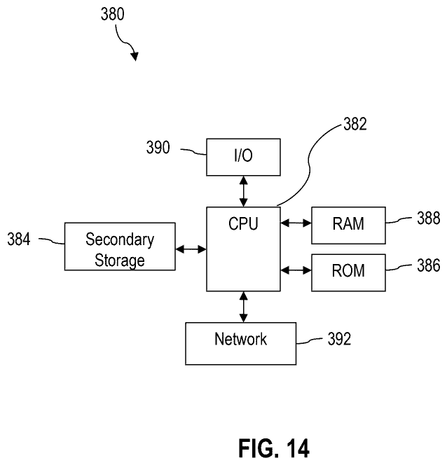

Turning now to FIG. 2, a secured inter-agency communication method 200 is described. The method 200 illustrates operations performed by various components of the network 100. Specifically, the components include agency A 120, the inter-agency communication system 102 including the fabric hub 104 and the fabric junction 112, and agency B 130. However, it is contemplated that other component(s) of the network 100 may be involved in performing the operations of the method 200. In embodiments, each of agency A 120, agency B 130, the fabric hub 104, and the fabric junction 112 may implement the operations of the method 200 using a computer system with components as shown in FIG. 14. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

At operation 202, agency B 130 may transmit, and the fabric management application 110 at the fabric hub 104 may receive, a first connection request to connect to the fabric hub 104. The first connection request may include a first login credential (e.g., a name and a password) of agency B 130. In one example, the first connection request may be manually initiated by an administrator of agency B 130. In another example, the first connection request may be automatically initiated by the management assistant application 124 at the computing system 122 of agency B 130.

At operation 204, in response to the first connection request, the fabric management application 110 may issue a first certificate to agency B 130 to establish a trusted relationship with agency B 130 and update the directory 107 at the fabric hub 104. For instance, the directory 107 may indicate agency B 130 is a trusted agency of the inter-agency communication system 102 and is available for communication over the inter-agency communication system 102. The trusted relationship may be established based on a verification (or authentication) of the first login credential of agency B 130 and a verification of organization information associated with agency B 130. The verification of the agency B 130's organization information may include a verification of a location (e.g., a county, a city, a state, a region, etc.), an agency type (e.g., law enforcement, police departments, fire departments, search and rescue, medics, federal agency, state agency, local agency, etc.), and/or an actual name of agency B 130. In an example, the verification of the agency B 130's organization information may be performed in coordination with an external company or party that provides an automatic company verification process (e.g., during a setup time or at a contractual time).

The first certificate may include tags (channel accessibility tags) indicating attributes associated with agency B 130's channel accessibility in the inter-agency communication system 102. In an embodiment, the agency B 130's channel accessibility tags in the first certificate may include at least one of a first tag indicating a geographical area (e.g., a city, a state, a region, etc.) at which the agency B 130 is located, a second tag indicating a mission or intended purpose (e.g., search and rescue, emergency response, medics, etc.) of agency B 130, a third tag indicating an organization (e.g., law enforcement, police, fire department, swat, state patrol, etc.) of agency B 130, a fourth tag indicating security level information (e.g., federal clearance, state clearance, territory clearance, etc.) associated with agency B 130, or a fifth tag indicating urgency level information (e.g., an urgency level, such as high, medium, or low, or at any suitable urgency level granularities) associated with agency B 130. In an embodiment, the first certificate may further include identification information of agency B 130, an IANA assigned PEN identifying a provider of the fabric junction 112, and an association between the PEN and the agency B 130's tags. In an example, the first certificate may be generated based on the ITU X.509 standard. In general, the first certificate may include various other information (e.g., version, publisher, issuer, signature, public key information, etc.) as will be discussed more fully below with reference to FIG. 3. In some instances, the fabric management application 110 may store the first certificate in the certificates and keys repository 108 of the fabric hub 104.

At operation 206, the fabric management application 110 may transmit, and agency B 130 may receive, the first certificate. In some instances, agency B 130 may store and/or configure the first certificate at the agency B 130's computing system 132.

At operation 208, agency A 120 may transmit, and the fabric management application 110 at the fabric hub 104 may receive, a second connection request to connect to the fabric hub 104. The second connection request may include a second login credential (e.g., a name and a password) of agency A 120. In one example, the second connection request may be manually initiated by an administrator of agency A 120. In another example, the second connection request may be automatically initiated by the management assistant application 134 at the computing system 132 of agency B 130.

At operation 210, in response to the second connection request, the fabric management application 110 may issue a second certificate (e.g., ITU X.509 certificate) to agency A 120 to establish a trusted relationship with agency A 120 and update the directory 107 at the fabric hub 104 using substantially similar mechanisms as discussed at operation 204. Further, similar to the first certificate, the second certificate may include tags indicating attributes associated with agency A 120's channel accessibility in the inter-agency communication system 102 and various other information as will be discussed more fully below with reference to FIG. 3. In some instances, the fabric management application 110 may store the second certificate in the certificates and keys repository 108 of the fabric hub 104.

At operation 212, the fabric management application 110 may transmit, and agency A 120 may receive, the second certificate. In some instances, agency A 120 may store and/or configure the second certificate at the agency A 120's computing system 122.

At operation 214, agency A 120 may transmit, and the fabric management application 110 may receive, a channel creation request to create a channel for communications with another agency in the inter-agency communication system 102. The channel creation request may include an allow tag and/or a deny tag, where an agency issued with a certificate including a channel accessibility tag matches to the allow tag may access the channel and an agency having a certificate including a channel accessibility tag matches to the deny tag may be denied access to the channel.

In an embodiment, the channel creation request may further include a textual name (e.g., human-readable name) of the channel and a unique identifier of the channel (uniquely identifying the channel the inter-agency communication system 102). In an embodiment, the channel creation request may further include a crypto password associated with an encryption for communications over the channel. In an example, the crypto password may be used (e.g., by the agency B 130) during a derivation of an encryption key. An example of parameters and/or fields associated with a channel creation request is shown in FIG. 4B.

In one embodiment, the channel creation request may be manually initiated by the administrator of agency A 120, for example, based on an occurrence of an emergency event. In another embodiment, the channel creation request may be automatically initiated by the management assistant application 124 of agency A 120 based on an automatic channel publishing rule related to an emergency event (e.g., terrorism, impending storm, school emergency, natural disaster, etc.). For instance, the management assistant application 124 may be preconfigured (e.g., by the fabric hub 104) with a rule to automatically create a channel to communicate with agency B 130 (e.g., FEMA) upon the occurrence of a certain emergency event.

At operation 216, in response to the channel creation request, the fabric management application 110 may update the directory 107 to publish the channel in the directory 107, e.g., via the UI 106, as will be discussed more fully below with reference to FIGS. 4A-4D.

In an embodiment, the fabric management application 110 may define and preconfigure channel categories for channels that are to be established in the inter-agency communication system 102 and an agency may create a new channel and may tag that channel with tags associated with those channel categories. In an example, the channel categories may include a first category related to a mission or an intended purpose (e.g., search and rescue, emergency response, medics, etc.) of an agency, a second category related to a geographical area (e.g., a city, a state, a region, etc.) of the agency, a third category related to an organization (e.g., law enforcement, police, fire department, swat, state patrol, FEMA, etc.) of an agency, a fourth category related to a security level (e.g., federal clearance, state clearance, territory clearance, etc.) of an agency, and/or a fifth category related to an urgency level (e.g., high, medium, or low, or at any suitable urgency level granularities).

At operation 220, agency B 130 may transmit, and the fabric management application 110 may receive, a channel subscription request to subscribe to the agency A 120's channel. For instance, agency B 130 may search for a channel in the directory 107 (e.g., via the UI 106 of the fabric hub 104). In one example, a user or administrator of agency B 130 may access the UI 106 via a web browser to search the directory 107. In another example, the management assistant application 134 of the agency B 130 may search the directory 107 via application programming interface (API) calls or secured hypertext transfer protocol (HTTP) requests (e.g., over a secured connection after connecting the fabric hub 104 at operation 202). In yet another example, the computing system 132 (or the management assistant application 134) of the agency B 130 may be integrated with other systems to perform the operation 220. The agency B 130 may determine to subscribe to the channel of agency A 120 based on at least one of the (channel accessibility) tags associated with agency B 130 matching the channel's allow tag, if present, and none of the (channel accessibility) tags associated with agency B 130 matches the channel's deny tag, if present. In some instances, the fabric management application 110 may filter the available channels in the directory 107 based on the (channel accessibility) tags associated agency B 130 and allow and/or deny tags of the available channels to ease agency B 130 in searching for a channel. Stated differently, the fabric management application 110 may filter out channels that agency B 130 are not allowed to access. For instance, the fabric management application 110 may filter out a channel when one or more of the agency B 130's tags match the deny tags of that channel or when none of the agency B 130's tags match the allow tags of that channel.

In an embodiment, the fabric management application 110 may further ease inter-agency communications by automatically notifying a relevant agency of a published channel (e.g., as an indication to request or invite the relevant agency to subscribe to the channel). As shown, at operation 218, the fabric management application 110 may transmit, and agency B 130 may receive, a notification of the publishing of the channel of agency A 120. The notification may be based on a verification of the tags associated with agency B 130 against the allow tag and/or the deny tag of the agency A 120's channel. For instance, the verification may include a determination that at least one of the tags associated with agency B 130 matches the allow tag of the agency A 120's channel or a determination that none of the tags associated with the agency B 130 matches the deny tag of the agency A 120's channel. In such an embodiment, the subscription request received from agency B 130 at operation 220 may be transmitted by the management assistant application 134 of the agency B 130 in response to the notification. As an example, agency A 120 may correspond to a Tampa search and rescue team, agency B 130 may correspond to FEMA, and the channel may have an allow tag “FEMA”. As such, the fabric management application 110 may automatically notify agency B 130 (FEMA) of the channel published by agency A 120 and agency B 130 may immediately subscribe to the channel, thereby greatly reducing channel setup time.

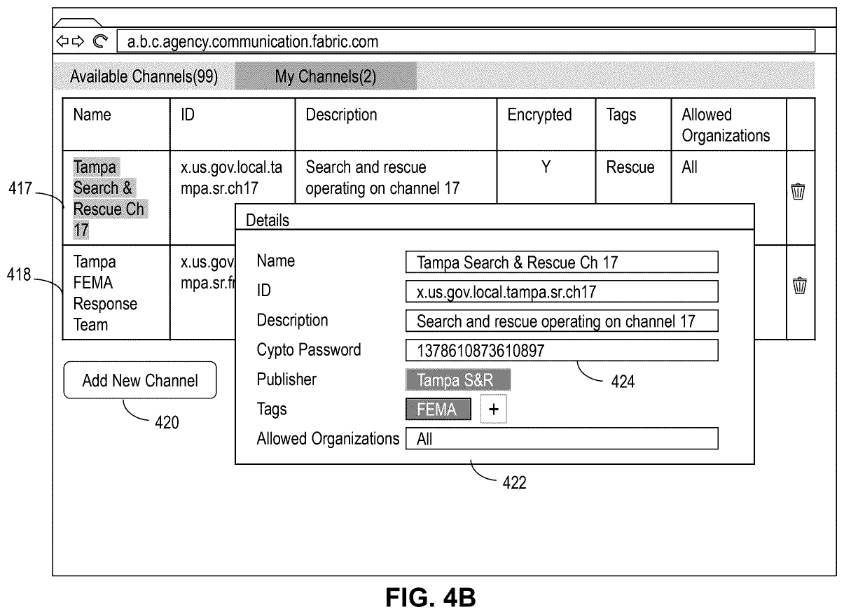

At operation 222, based on the notification of the published channel (at operation 218) and/or the channel subscription request from agency B 130 (at operation 220), the fabric management application 110 may configure a set of rules 114 at the fabric junction 112. The set of rules 114 may be based at least in part on the agency B 130's channel accessibility tags and the agency A 120's channel allow tag and/or the deny tag. In embodiments, the set of rules 114 may include an indication of a file location (e.g. at the certificates and keys repository 108) at which the first certificate of agency A 120 is stored, a file location (e.g. at the certificates and keys repository 108) at which the second certificate of agency B is stored, channel accessibility tags associated with agency A 120, channel accessibility tags associated with agency B 130, and/or channel access restriction tags (e.g., an allow tag and/or a deny tag) of the channel. As will be discussed more fully below with reference to FIGS. 5-9, the rules 114 may include a channel access rule allowing or denying an agency to access the channel based on channel accessibility tags of a certificate to which the respective agency is issued. Additionally or alternatively, the rules 114 may include a channel access rule allowing or denying an agency to access the channel based on a serial number of a certificate to which the respective agency is issued. Additionally or alternatively, the rules 114 may include a channel access rule allowing or denying an agency to access the channel based on information associated with an issuer of a certificate to which the respective agency is issued.

At operation 224, the fabric management application 110 may transmit, and the fabric junction 112 may receive, the set of rules 114 (e.g., the management traffic 160).

At operation 226, the fabric junction 112 (or more specifically the routing engines 116) may route communications 228 (e.g., texts, data, and/or voice) from agency A 120 to agency B 130 and route communications 230 (e.g., texts, data, and/or voice) from agency B 130 to agency A 120 over the channel according to the set of rules 114. In an embodiment, the fabric junction 112 may authenticate a connection with agency A 120 and authenticate a connection with agency B 130 for communication over the channel according to the set of rules 114 prior to routing the communications between agency A 120 and agency B 130.

In an embodiment, as part of the authentication and/or the routing, the fabric junction 112 may request agency A 120 for agency A 120's certificate and verify the agency A 120's certificate against a respective certificate stored at a location (e.g., at the certificates and keys repository 108) as indicated by the rules 114. In a similar way, the fabric junction 112 may request agency B 130 for agency B 130's certificate and verify the agency B 130's certificate against a respective certificate stored at a location (e.g., at the certificates and keys repository 108) as configured by the rules 114. The fabric junction 112 may further inspect the channel accessibility tags of agency A 120 in the agency A 120's certificate against the channel access restriction tags of the agency B 130's channel as configured by the rules 114.

While FIG. 2 illustrates a channel created by agency A 120 and agency B 130 subscribes to the channel, in other examples, agency B 130 may create a channel and agency A 120 may subscribe to the channel using substantially similar mechanisms. Further, an agency can create a channel in the inter-agency communication system 102 to communicate with multiple agencies (e.g., for multicast communication). In general, the fabric hub 104 may support unicast channels and/or multicast channels for cross-agency communications.

Turning now to FIG. 3, an exemplary certificate 300 issued to a trusted agency is described. In the illustrated example of FIG. 3, the certificate 300 is issued to New York police department (NYPD) swat team. In an embodiment, the certificate 300 is an ITU X.509 certificate. As shown in FIG. 3, the certificate 300 may include a version field 302, a serial number field 304, a signature algorithm identifier field 306, an issuer name field 308, a validity period field 310, a subject name field 312, a public key information field 314, and a signature field 316.

The version field 302 indicates the X.509 version of the certificate 300. The serial number field 304 is a unique number issued by an authority (e.g., a provider of the inter-agency communication system 102 or the fabric hub 104). The signature algorithm identifier field 306 indicates the algorithm used for signing the certificate 300. The issuer name field 308 indicates the ITU X.500 name of the authority which signed and created the certificate 300. The validity period field 310 indicates the period for which the certificate 300 is valid. The subject name field 312 indicates the name of the agency to whom this certificate 300 has been issued. Additionally, the subject name field 312 includes an IANA issued PEN identifying a provider of the fabric junction 112, and an association between the PEN and tags that indicate channel accessibility of the agency. In the illustrated example of FIG. 3, the agency to whom this certificate 300 has been issued is a police swat team in New York city, the PEN for the provider of the fabric junction 112 is 1.3.6.1.4.1.ABC, and the agency's tags include “uslawenforcement”, “swat”, “antiterror”, and “usnortheast”. The public key information field 314 indicates the agency's public key along with an identifier of the algorithm for which this key is to be used. The public key information field 314 may further include the public key. The signature field 316 may include the hash code of all other fields which is encrypted by the private key of the authority that issues the certificate 300.

FIG. 3 is merely an example of components of a certificate for a trusted agency, and variations are contemplated to be within the scope of the present disclosure. In embodiments, the certificate may include other fields not illustrated in FIG. 3. In embodiments, the certificate may not include every field illustrated in FIG. 3. Such and other embodiments are contemplated to be within the scope of the present disclosure.

Turning now to FIGS. 4A-4D, an example of the UI 106 for a directory service for secured inter-agency communications is described. In the illustrated examples of FIGS. 4A-4D, the UI 106 is shown as a web browser interface when an agency, named “Tampa rescue and research” is logged into (e.g., a portal of) the fabric hub 104. As shown in FIG. 4A, the UI 106 may include a browser page 404 for channels created and owned by Tampa rescue and search agency and a browser page 402 for available channels created and owned by other agencies.

FIG. 4A shows a UI 106 depicting the browser page 404 when the browser page 404 is selected. As shown, the browser page 404 includes, for each channel 417, 418, a name field 406, an identifier (ID) field 408, a description field 410, an encryption enabled field 412, a tag field 414, and an allowed organizations field 416. The name field 406 indicates a (human-readable) name of the respective channel. The ID field 408 indicates an ID of the respective channel, e.g., uniquely identifying the respective channel in the inter-agency communication system 102. The description field 410 provides a description of the respective channel, e.g., indicating an intended purpose of the channel and/or a communication channel number (or channel frequency). The encryption enabled field 412 indicates whether encryption is enabled for the respective channel. The tags field 414 indicates channel access restriction tags (e.g., allow tags and/or deny tags) for the respective channel. The allowed organizations field 416 indicates organizations that are allowed access to the channel. As further shown in FIG. 4A, the browser page 404 may include an “add new channel” button 420. The channels 417 and 418 may be added (created) by clicking on the “add new channel” button 420.

FIG. 4B illustrates a pop-up window 422 illustrating further details about the channel 417, for example, further including a publisher of the channel 417 and a crypto password 424 to be used for encryption communications over the channel 417. In the pop-up window 422, the empty-filled boxes are editable, and the greyed-out boxes may not be editable. In an embodiment, the tags are preconfigured by the fabric hub 104 (shown by the greyed-out box). An agency creating a channel can add channel access tags by selecting from the preconfigured tags (e.g., associated with the preconfigured channel categories discussed above with reference to FIG. 2).

FIG. 4C shows a UI 106 depicting the browser page 402 when the browser page 402 is selected. As discussed above, the browser page 402 lists channels available in the directory 107. For simplicity, FIG. 4C illustrates 6 available channels. In general, the UI 106 may list any suitable number of channels available in the directory 107. As shown in FIG. 4C, the browser page 402 includes, for each channel 440, 442, 444, 446, 448, and 450, a name 428, an identifier (ID) field 430, a description field 432, an encryption enabled field 434, and a publisher field 436. The name field 406, the ID field 430, description field 432, and the encryption field 434 may be substantially similar to the name field 406, the ID field 408, description field 410, and the encryption field 412, respectively, discussed above with reference to FIG. 4A. The publisher field 436 indicates the name of the agency that publishes the respective channel. As further shown in FIG. 4C, the browser page 402 may include an editable box 426 to allow a user to enter IDs, names, and/or tags to search for channels.

FIG. 4D illustrates a pop-up window 452 illustrating further details about the channel 446, for example, further including a crypto password 454 to be used for encryption for communications over the channel 446, an allow tag 456 for the channel 446, and organizations that are allowed to access the channel 446.

FIGS. 4A-4D are merely example of components of a UI for an inter-agency communication directory service, and variations are contemplated to be within the scope of the present disclosure. In embodiments, the UI may include other components not illustrated in FIGS. 4A-4D. In embodiments, the UI may not include every component illustrated in FIGS. 4A-4D. Such and other embodiments are contemplated to be within the scope of the present disclosure.

In an embodiment, a channel configuration file for a channel in the inter-agency communication system 102 may include at least an identifier and a name of the channel. The identifier may be a unique string by which the channel is identified in the inter-agency communication system 102. The name may be a human-readable name. If encryption is used for the channel, the channel configuration file may further include a crypto password (e.g., a hexadecimal representation the binary password used to derive a channel encryption key, such as a symmetric channel encryption key). In general, the channel configuration may include various other information, such as an audio encoder to be used for encoding audio over the channel, mechanisms for transmitting audio, the host address (e.g., the Internet Protocol (IP) address) of the inter-agency communication system 102, the port (e.g., TCP port) to be used for connecting to the fabric junction 112. In an example, the channel configuration file may be a Java script object notation (JSON) file.

In an embodiment, a channel configuration file may include allow tags and/or deny tags to respectively allow certain agencies to access a respective channel and/or deny certain agencies to access the respective channel. The allow tags and/or deny tags may be regular expressions that may be applied against the channel accessibility tags of an agency (e.g., the tags in the certificate issued to the agency) when determining whether the agency is allowed or not allowed to access the channel.

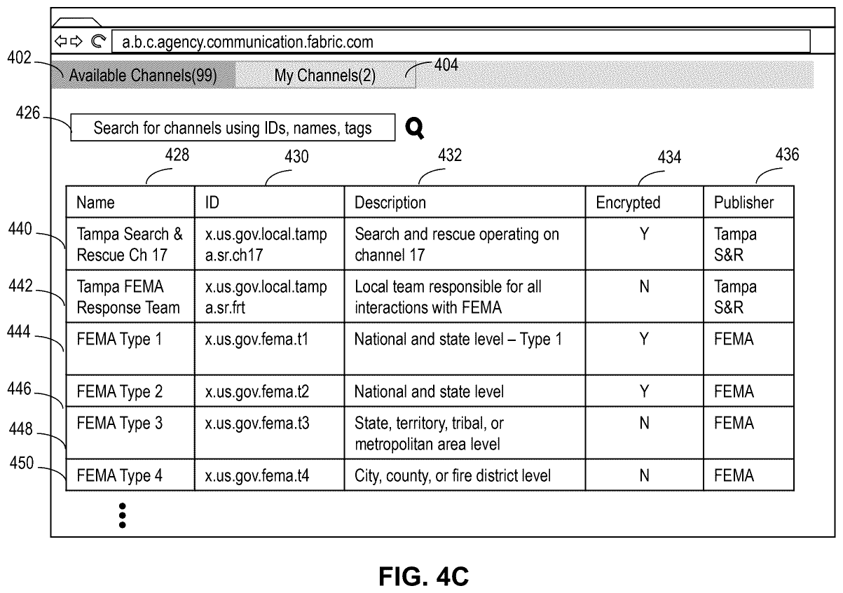

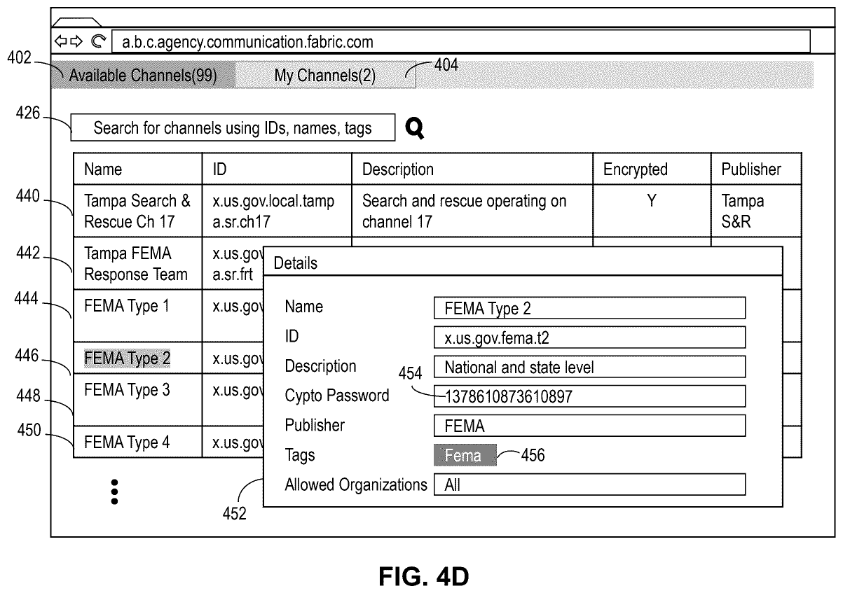

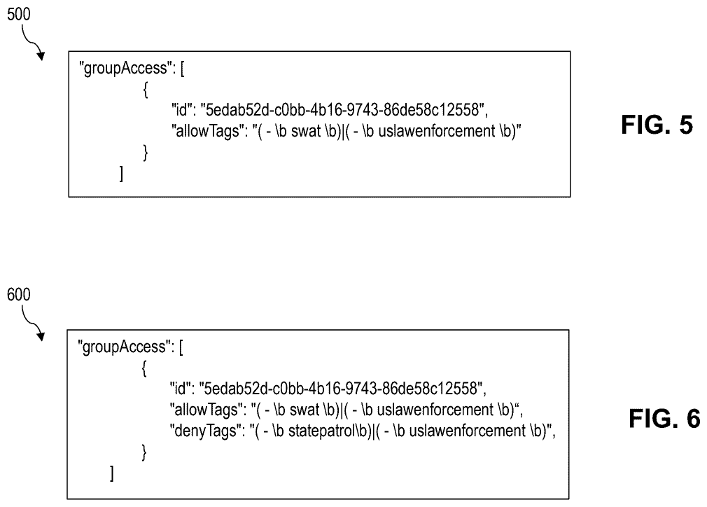

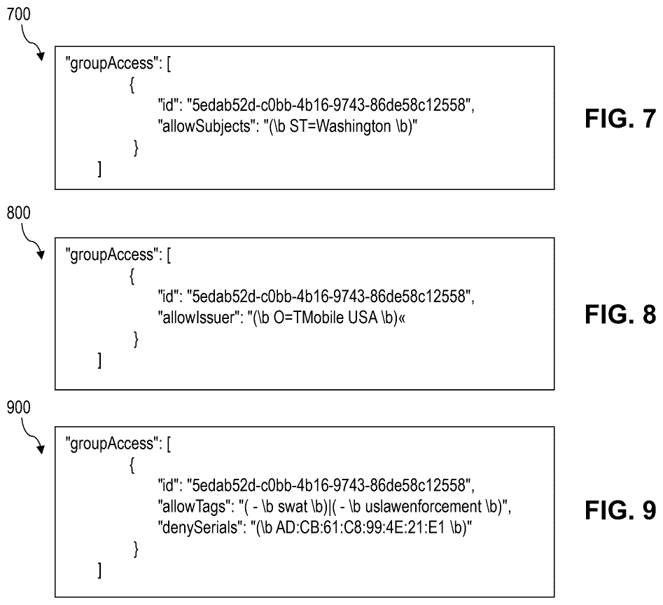

FIGS. 5-9 illustrate various examples of channel configurations 500, 600, 700, 800, and 900 that may be included in a channel configuration file to control access to a channel with an identifier “5edab52d-c0bb-4b16-9743-86de58c12558”. For instance, in FIG. 5, the channel configuration 500 allows agencies with certificates that have at least “-swat” or “-uslawenforcement” tags to access the channel. In FIG. 6, the channel configuration 600 is similar to the channel configuration 500, but further denies agencies with certificates that have a “-statepatrol” tags to access the channel. In FIG. 7, the channel configuration 700 allows agencies with certificates that were issued to entities (e.g., agencies) in Washington state to access the channel. In FIG. 8, the channel configuration 800 allows agencies with certificates that were issued by TMobile USA to access the channel. In FIG. 9, the channel configuration 900 denies an agency with a specific certificate with a serial number “AD:CB:61:C8:99:4E:21:E1” to access the channel.

In general, a channel configuration may include allow rules and/or deny rules to restrict channel access to a certain agency or a certain group of agencies but not others based on tags, serial numbers, and/or issuer information in certificates issued to agencies (e.g., including any suitable combinations of channel configuration 500, 600, 700, 800, and 900). In an embodiment, the channel configurations 500, 600, 700, 800, and/or 900 may be included in a channel configuration file (e.g., JSON file), and the fabric hub 104 may configure the fabric junction 112 with the channel configuration file (e.g., via RESTful API over the management traffic 160).

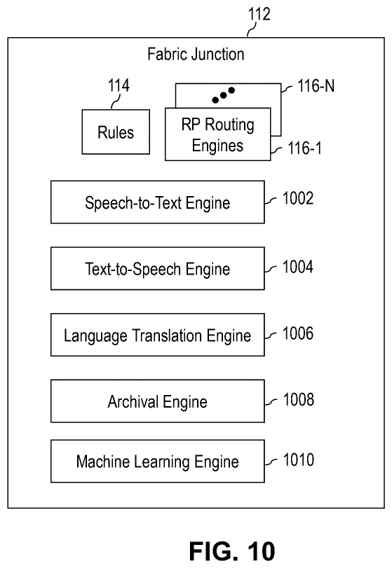

Turning now to FIG. 10, the fabric junction 112 is described in more detail. To further ease and enrich inter-agency communications, the fabric junction 112 may further include a speech-to-text engine 1002, a text-to-speech engine 1004, a language translation engine 1006, an archival engine 1008, and/or a Machine Learning (ML) engine 1010. The speech-to-text engine 1002, the text-to-speech engine 1004, the language translation engine 1006, the archival engine 1008, and/or the ML engine 1010 may include software components, hardware components, or a combination thereof. The operations of the speech-to-text engine 1002, the text-to-speech engine 1004, the language translation engine 1006, the archival engine 1008, and/or the ML engine 1010 will be discussed in connection with FIGS. 1 and 2 where the fabric junction 112 is configured to route communications between agency A 120 and agency B 130 over a channel of agency A 120.

In an embodiment, a user of agency A 120 using one of the RP devices 140a-140b may use texts for communication while a user of agency B 130 using one of the RP devices 140c-140f may use voice for communication. In such an embodiment, as part of routing the communications between agency A 120 and agency B 130, the fabric junction 112 may receive, from agency A 120 in the channel, a first communication including first textual data. The text-to-speech engine 1004 may convert the first textual data to first voice data, and the fabric junction 112 may transmit, to agency B 130, a second communication comprising the first voice data. As part of routing the communications, the fabric junction 112 may further receive, from agency B 130 in the channel, a third communication comprising second voice data. The speech-to-text engine 1002 may convert the second voice data to second textual data, and the fabric junction 112 may transmit, to agency A 120 in the channel, a fourth communication comprising the second textual data. In one example, the first textual data may be transmitted by agency A 120 in response to the second textual data converted by the speech-to-text engine 1002 from the second voice data (of agency B 130). In another example, the second voice data may be transmitted by agency B 130 in response to the first voice data converted by the text-to-speech engine 1004 from the first textual data (of agency A 120). In another embodiment, a user of agency A 120 using one of the RP devices 140a-140b may use voice for communication while a user of agency B 130 using one of the RP devices 140c-140f may use texts for communication, where the text-to-speech engine 1004 and the speech-to-text engine 1002 may operate as discussed above. The speech-to-text engine 1002 and the text-to-speech engine 1004 may be built based on AI algorithms known in the art (e.g., deep learning, recurrent neural networks (RNNs), natural language processing (NLP), large language models (LLMs), etc.).

In an embodiment, a user of agency A 120 using one of the RP devices 140a-140b may communicate with a user of agency B 130 using one of the RP devices 140c-140f via voice, but each user may use a different language. As an example, the agency A 120's user may be an English-speaking person while the agency B 130's user may be a non-English-speaking person. As an example, the agency A 120's user may speak a certain dialect (which may be a form of language in a certain region) while the agency B 130's user may speak a different dialect. In such an embodiment, as part of routing the communications between agency A 120 and agency B 130, the fabric junction 112 may receive, from agency A 120 in the channel, a first communication including first voice data in a first language. The language translation engine 1006 may translate the first voice data from the first language to a second language, and the fabric junction 112 may transmit, to agency B 130 in the channel, a second communication including the translated first voice data. Further, the fabric junction 112 may receive, from agency B 130 in the channel, a third communication including second voice data in the second language. The language translation engine 1006 may translate the second voice data from the second language to the first language, and the fabric junction 112 may transmit, to agency A 120 in the channel, a fourth communication including the translated second voice data. In one example, the first voice data may be transmitted by agency A 120 in response to the second translated voice data translated by the language translation engine 1006 from the second voice data (of agency B 130). In another example, the second voice data may be transmitted by agency B 130 in response to the first translated voice data translated by the language translation engine 1006 from the first voice data (of agency A 120). The language translation engine 1006 may be built based on AI algorithms known in the art (e.g., deep learning, RNNs, NLP, LLMs, etc.). In general, the speech-to-text engine 1002, the text-to-speech engine 1004, and the language translation engine 1006 may be arranged and combined in any suitable way to allow natural communications, which when used with NLP may be able to understand and respond to any users, overcoming language and/or dialect differences, and/or grammatical errors.

In an embodiment, one of agency A 120 or agency B 130 may desire to archive communications over the channel. For instance, agency A 120 may transmit, to the fabric junction 112, an archival request to archive the communications (e.g., initiated by agency A 120 and/or initiated by agency B 130), which may include text messages, photos, and/or voice, communicated over the channel. In response, the fabric junction 112 may archive the communication over the channel at a memory. In an example, the memory may be at a cloud storage (e.g., a Sarbanes-Oxley Act compliant cloud) or any suitable storage, for example, selected by agency A 120. In an example, the memory may be provided by a cloud service used by the fabric junction 112. In another example, the memory may be provided by a cloud service used by agency A 120. As part of archiving the communications at the memory, the fabric junction 112 may forward each packet received from agency A 120 (for transmission over the channel) and/or each packet received from agency B 130 (for transmission over the channel) to a cloud at which the memory is located.

In an embodiment, agency A 120 or agency B 130 may query information from a controlled dataset, and the fabric junction 112 may contextualize the requested information and combine with LLMs to provide a relevant and well-informed answer. For instance, the fabric junction 112 may receive, from agency A 120, a query. The fabric junction 112 may process the query and information (e.g., channel accessibility tags) in the agency A 120's certificate using the ML engine 1010. The ML engine 1010 may output an indication of a particular agency (e.g., an agency C) that may have a response for that query. The fabric junction 112 may transmit, to the particular agency, the query. The fabric junction 112 may receive, from the particular agency, a response for the query. The fabric junction 112 may transmit, to agency A 120, a response for the query. As an example, a highway patrol (e.g., agency A 120) may query for information associated with a license plate at a traffic stop, and the ML engine 1010 may output an indication of a department of motor vehicles (e.g., the particular agency) where the license-plate information may be retrieved. The ML machine 1010 may be built based on AI algorithms known in the art (e.g., deep learning, generative AI, NLP, LLMs, etc.). In an example, the ML engine 1010 may be trained using training data including a plurality of data sets including historical data associated with queries. For instance, each data set may include a query, a requesting agency's channel accessibility tags, a responding agency, and a response to the query data. The query and the requesting agency's channel accessibility tags may be used as input to the ML engine 1010, and the responding agency and the response may be used as ground truths. In a further example, the training data may include data sets, each including an incident-type (e.g., types of federal disasters) and one or more agencies to be informed of such an incident-type, where the one or more agencies are the ground truths for the training. In such an example, a user of agency A 120 or agency B 130 may send an indication of an incident instead of a query, and the ML engine 1010 may output an indication of a particular agency to be informed of the incident. The fabric junction 112 may transmit, to the particular agency, a report of the incident. Stated differently, the fabric junction 112 may automatically report the incident to a relevant agency.

In an embodiment, a user of agency A 120 using an RP device (e.g., the RP device 140a) may query certain information (e.g., from a controlled dataset) via voice. The speech-to-text engine 1002 may convert the voice into text, and the ML engine 1010 may process the query (in the text format) to determine an agency that may provide an answer for the query. In some instances, the RP device 140a may include a voice detector and may monitor for a sentence beginning with a specific phrase (e.g., “Hey fabric”) from a user. When the RP device 140a detects the specific phrase, the RP device 140a may transmit the sentence to the fabric junction 112 for processing, for example, using one or more of the components of the fabric junction 112 as discussed above. As an example, the user may say a sentence “Hey fabric, get license-plate information for XXXX”, the RP device 140a may detect and transmit the sentence to the fabric junction 112, the speech-to-text engine 1002 (at the fabric junction 112) may convert the sentence from voice to texts, the ML engine 1010 (at the fabric junction 112) may determine an agency (e.g., a department of motor vehicles), and retrieve the requested information from the agency as discussed above.

FIG. 10 is merely an example of components of a fabric junction in an inter-agency communication system 102, and variations are contemplated to be within the scope of the present disclosure. In embodiments, the fabric junction may include other components not illustrated in FIG. 10. In embodiments, the fabric junction may not include every component illustrated in FIG. 10. Such and other embodiments are contemplated to be within the scope of the present disclosure.

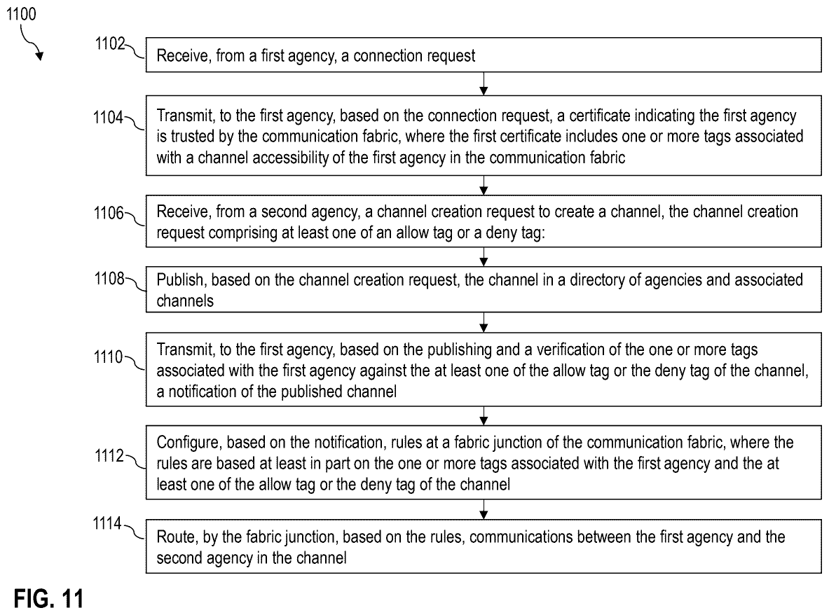

Turning now to FIG. 11, a method 1100 is described. In an embodiment, the method 1100 is a method of providing secured inter-agency communication with automatic channel publish notification. The method 1100 may include similar mechanisms as discussed above with reference to FIGS. 1-3, 4A-4C, and 5-10. In embodiments, the method 1100 may be implemented using a computer system with components as shown in FIG. 14. As illustrated, FIG. 11 includes a number of enumerated operations, but embodiments of the operations in FIG. 11 may include additional operations before, after, and in between the enumerated operations. In some embodiments, one or more of the enumerated operations may be omitted or performed in a different order.

At block 1102, a fabric management application 110 at a computing system 104 associated with a communication system 102 receives a connection request from a first agency (e.g., one of agency A 120 or agency B 130).

At block 1104, the fabric management application 110 transmits, to the first agency, based on the connection request, a certificate (e.g., the certificate 300) indicating the first agency is trusted by the communication system 102. The certificate includes one or more tags indicating one or more respective attributes associated with a channel accessibility of the first agency in the communication system 102.

In an embodiment, the transmitting the certificate is further based on a verification of at least one of a location of the first agency, an agency type of the first agency, or a name (e.g., actual name, such as FEMA or Tampa search and rescue) of the first agency. In an embodiment, the one or more tags associated with the first agency in the certificate comprises at least one of a first tag indicating a geographical area at which the first agency is located, a second tag indicating a mission of the first agency, a third tag indicating an organization associated with the first agency, a fourth tag indicating security level information associated with the first agency, or a fifth tag indicating urgency level information associated with the first agency. In an embodiment, the certificate further includes information identifying the first agency and an IANA assigned PEN identifying a provider of the fabric junction, and an association between the PEN and the one or more tags associated with the first agency.

At block 1106, the fabric management application 110 receives, from a second agency (e.g., the other one of agency A 120 or agency B 130) trusted by the communication system 102, a channel creation request to create a channel (e.g., the channels 440, 442, 444, 446, 448, 450). The channel creation request includes at least one of an allow tag indicating an attribute of an agency allowed to access the channel or a deny tag indicating an attribute of an agency prohibited from accessing the channel. In an embodiment, the channel creation request further includes at least one of a textual name of the channel or a unique identifier of the channel. In an embodiment, the channel creation request further includes a crypto password associated with an encryption for the communications in the channel (e.g., when the channel is encrypted). In an embodiment, the at least one of the allow tag or the deny tag of the channel includes an indication of at least one of a geographical area, a mission, an organization, a security level, or an urgency level.

At block 1108, the fabric management application 110 publishes, based on the channel creation request, the channel in a directory 107 of agencies and associated channels.

At block 1110, the fabric management application 110 transmits, to the first agency, based on the publishing and a verification of the one or more tags associated with the first agency against the at least one of the allow tag or the deny tag of the channel, a notification of the published channel.

At block 1112, the fabric management application 110 configures, based on the notification, rules 114 at the fabric junction 112 of the communication system 102, where the fabric junction 112 includes a plurality of routing engines 116. The rules 114 are based at least in part on the one or more tags associated with the first agency and the at least one of the allow tag or the deny tag of the channel. In an embodiment, as part of configuring the rules 114, the fabric management application 110 verifies that at least one of the one or more tags associated with the first agency matches the allow tag of the channel and/or verifies that none of the one or more tags associated with the first agency matches the deny tag of the channel.

At block 1114, the fabric junction 112 (or more specifically the routing engines 116) routes, based on the rules 114, communications between the first agency and the second agency in the channel.

In an embodiment, the fabric management application 110 further receives, from the first agency, based on the notification of the published channel (of the second agency), a request to subscribe to the channel.

In an embodiment, the fabric junction 112 further establishes a connection with the second agency based on a verification of the one or more tags associated with the first agency against the at least one of the allow tag or the deny tag of the channel.

In an embodiment, as part of routing the communication at block 1114, the fabric junction 112 receives, from one of the first agency or the second agency in the channel, a first communication including textual data. The fabric junction 112 further converts, using a text-to-speech engine 1004 at the fabric junction 112, the textual data to voice data. The fabric junction 112 further transmits, to the other one of the first agency or the second agency in the channel, a second communication including the voice data.

In an embodiment, as part of routing the communication at block 1114, the fabric junction 112 receives, from one of the first agency or the second agency in the channel, a first communication including voice data. The fabric junction 112 further converts, using a speech-to-text engine 1002 at the fabric junction 112, the voice data to textual data. The fabric junction 112 further transmits, to the other one of the first agency or the second agency in the channel, a second communication including the textual data.

In an embodiment, as part of routing the communication at block 1114, the fabric junction 112 receives, from one of the first agency or the second agency in the channel, a first communication including voice data in a first language. The fabric junction 112 further translates, using a language translation engine 1006 at the fabric junction 112, the voice data from the first language to a second language. The fabric junction 112 further transmits, to the other one of the first agency or the second agency in the channel, a second communication including the translated voice data.

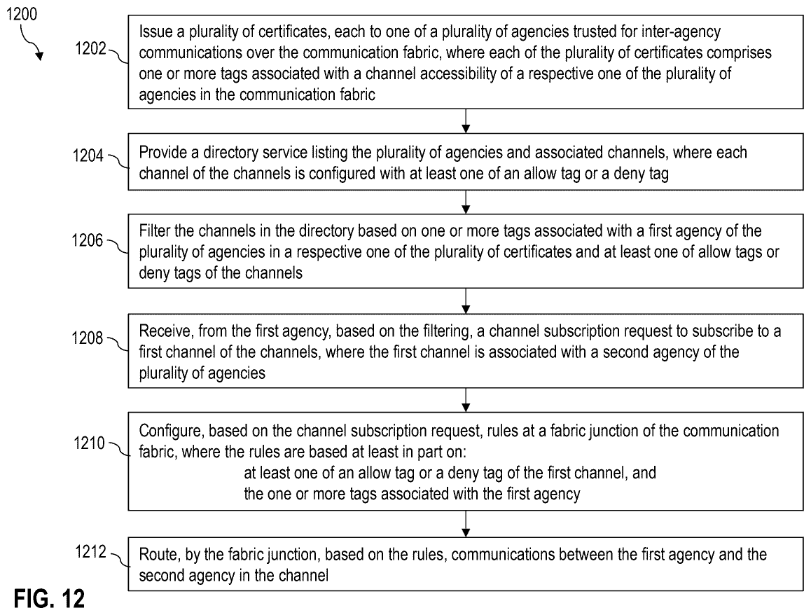

Turning now to FIG. 12, a method 1200 is described. In an embodiment, the method 1200 is a method of providing secured inter-agency communication and a directory service with channel filtering. The method 1200 may include similar mechanisms as discussed above with reference to FIGS. 1-3, 4A-4C, and 5-11. In embodiments, the method 1200 may be implemented using a computer system with components as shown in FIG. 14. As illustrated, FIG. 12 includes a number of enumerated operations, but embodiments of the operations in FIG. 12 may include additional operations before, after, and in between the enumerated operations. In some embodiments, one or more of the enumerated operations may be omitted or performed in a different order.

At block 1202, a fabric management application 110 at a computing system 104 associated with a communication system 102 issues a plurality of certificates (e.g., similar to the certificate 300), each to one of a plurality of agencies (e.g., agency A 120, agency B 130) trusted for inter-agency communications over the communication system 102. Each of the plurality of certificates includes one or more tags indicating one or more respective attributes associated with a channel accessibility of a respective one of the plurality of agencies in the communication system 102.

At block 1204, the fabric management application 110 provides, via a UI 106 at the computing system 104, a directory service listing the plurality of agencies and associated channels in a directory 107. Each channel of the channels is configured with at least one of an allow tag indicating an attribute of an agency allowed to access the respective channel or a deny tag indicating an attribute of an agency prohibited from accessing the respective channel.

At block 1206, the fabric management application 110 filters the channels in the directory 107 based on one or more tags associated with a first agency (e.g., one of agency A 120 or agency B 130) of the plurality of agencies in a respective one of the plurality of certificates and at least one of allow tags or deny tags of the channels.

At block 1208, the fabric management application 110 receives, from the first agency, based on the filtering, a channel subscription request to subscribe to a first channel of the channels, where the first channel is associated with a second agency (e.g., the other one of agency A 120 or agency B 130) of the plurality of agencies.

At block 1210, the fabric management application 110 configures, based on the filtering, rules 114 at a fabric junction 112 of the communication system 102, where the fabric junction 112 includes a plurality of routing engines 116. The rules 114 are based at least in part on at least one of an allow tag or a deny tag of the first channel and the one or more tags associated with the first agency.

At block 1212, the fabric junction 112 routes, based on the rules 114, communications over the first channel between the first agency and the second agency.

In an embodiment, a second channel of the channels is configured with at least one of a first channel access rule 114 allowing an agency to access the second channel based on a serial number (e.g., the serial number field 304 shown in FIG. 3) of a certificate to which the respective agency is issued, a second channel access rule 114 denying an agency to access the second channel based on a serial number of a certificate to which the respective agency is issued, a third channel access rule 114 allowing an agency to access the second channel based on information associated with an issuer (e.g., the issuer name field 308 shown in FIG. 3) of a certificate to which the respective agency is issued, or a fourth channel access rule 114 denying an agency to access the second channel based on information associated with an issuer of a certificate to which the respective agency is issued, for example, as discussed above.

In an embodiment, the fabric junction 112 further receives, from a third agency of the plurality of agencies, a query. The fabric junction 112 further processes, using an ML engine 1010 at the fabric junction 112, the query and at least one or more tags associated with a channel accessibility of the third agency in a respective one of the plurality of certificates to output an indication of a fourth agency of the plurality of agencies. The fabric junction 112 further transmits, to the fourth agency, the query. The fabric junction 112 further receives, from the fourth agency in response to the query, a response. The fabric junction 112 further transmits, to the third agency, the response.

In an embodiment, the fabric junction 112 further receives, from a third agency of the plurality of agencies, an indication of an incident (e.g., a type of federal disaster). The fabric junction 112 further processes, using an ML engine 1010 at the fabric junction 112, the query and at least one or more tags associated with a channel accessibility of the third agency in a respective one of the plurality of certificates to output an indication of a fourth agency of the plurality of agencies. The fabric junction 112 further transmits, to the fourth agency, a report of the incident.

In an embodiment, the fabric junction 112 further receives, from one of the first agency or the second agency, an archival request to archive the communications over the channel. The fabric junction 112 further archives, based on the archival request, the communications over the channel at a memory. In an example, the memory may be at a cloud storage or any suitable storage, and the fabric junction 112 may forward each packet received from the first agency over the channel and each packet received from the second agency over the channel to the memory as part of routing the communications between the first agency and the second agency.

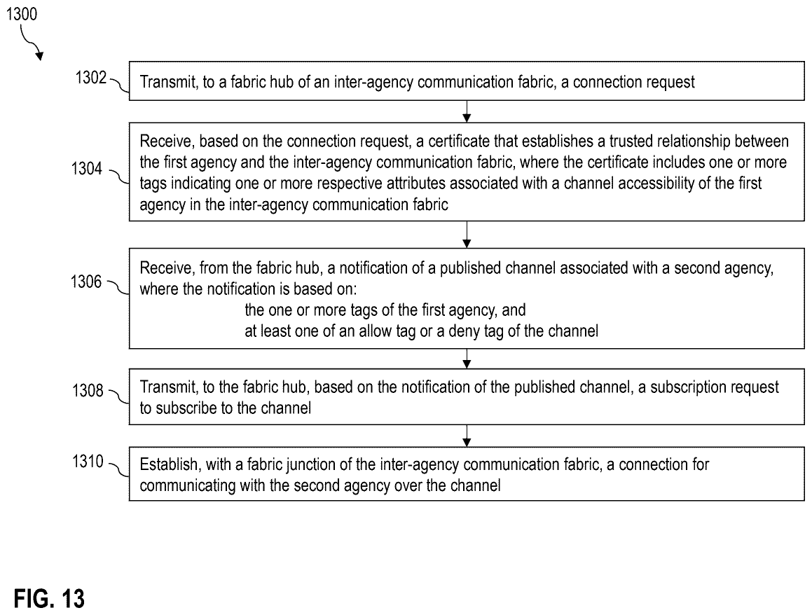

Turning now to FIG. 13, a method 1300 is described. In an embodiment, the method 1300 is a method of providing secured inter-agency communication with agency management assistance. The method 1300 may include similar mechanisms as discussed above with reference to FIGS. 1-3, 4A-4C, and 5-10. In embodiments, the method 1300 may be implemented using a computer system with components as shown in FIG. 14. As illustrated, FIG. 13 includes a number of enumerated operations, but embodiments of the operations in FIG. 13 may include additional operations before, after, and in between the enumerated operations. In some embodiments, one or more of the enumerated operations may be omitted or performed in a different order. While FIG. 13 is discussed in the context of the management assistant application 134 of agency B 130 performing the operations of the method 1300, in other examples, the management assistant application 124 of agency A 120 may perform the operations of the method 1300.

At block 1302, the management assistant application 134 at the computing system 132 of a first agency 130 transmits, to a fabric hub 104 of an inter-agency communication system 102, a connection request (e.g., including a login credential of the first agency 130).

At block 1304, the management assistant application 134 receives, from the fabric hub 104, based on the connection request, a certificate (e.g., the certificate 300) that establishes a trusted relationship between the first agency 130 and the inter-agency communication system 102. The certificate includes one or more tags indicating one or more respective attributes associated with a channel accessibility of the first agency 130 in the inter-agency communication system 102.

At block 1306, the management assistant application 134 receives, from the fabric hub 104, a notification of a published channel associated with a second agency 120. The notification is based on the one or more tags of the first agency 130 and at least one of an allow tag or a deny tag of the channel indicating respectively an attribute of an agency allowed access to the channel or an attribute of an agency denied access to the channel.

At block 1308, the management assistant application 134 transmits, to the fabric hub 104, based on the notification of the published channel, a subscription request to subscribe to the channel.

At block 1310, the management assistant application 134 establishes, with a fabric junction 112 of the inter-agency communication system 102, a connection for communicating with the second agency 120 over the channel.

In an embodiment, the notification of the published channel includes an indication of a crypto password associated with an encryption for communications over the channel. The management assistant application 134 configures one or more components at the first agency 130 with the crypto password.

In an embodiment, the management assistant application 134 transmits, to the fabric hub 104, based on an automatic channel creation rule, a channel creation request to create a second channel for communications with a third agency. The automatic channel creation rule may be associated with an emergency event. For instance, when an emergency associated with a natural disaster occurs, the first agency 130 may create a channel to communicate with a certain agency (e.g., FEMA).

FIG. 14 illustrates a computer system 380 suitable for implementing one or more embodiments disclosed herein. The computer system 380 includes a processor 382 (which may be referred to as a central processor unit or central processing unit (CPU)) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as code-division multiple access (CDMA), global system for mobile communications (GSM), LTE, WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication system to provide secured inter-agency communications with automatic channel publish notification, wherein the method comprises:
receiving, by a fabric management application at a computing system associated with a communication fabric, from a first agency, a connection request;
transmitting, by the fabric management application to the first agency, based on the connection request, a certificate indicating the first agency is trusted by the communication fabric, wherein the certificate comprises one or more tags indicating one or more respective attributes associated with a channel accessibility of the first agency in the communication fabric;
receiving, by the fabric management application from a second agency trusted by the communication fabric, a channel creation request to create a channel, the channel creation request comprising at least one of:
an allow tag indicating an attribute of an agency allowed to access the channel, or
a deny tag indicating an attribute of an agency prohibited from accessing the channel;
publishing, by the fabric management application, based on the channel creation request, the channel in a directory of agencies and associated channels;
transmitting, by the fabric management application to the first agency, based on the publishing and a verification of the one or more tags associated with the first agency against the at least one of the allow tag or the deny tag of the channel, a notification of the published channel;
configuring, by the fabric management application, based on the notification, rules at a fabric junction of the communication fabric, wherein the fabric junction comprises a plurality of routing engines, and wherein the rules are based at least in part on the one or more tags associated with the first agency and the at least one of the allow tag or the deny tag of the channel; and
routing, by the fabric junction, based on the rules, communications between the first agency and the second agency in the channel.

2. The method of claim 1, wherein the transmitting the certificate is further based on a verification of at least one of a location of the first agency, an agency type of the first agency, or a name of the first agency.

3. The method of claim 1, wherein the one or more tags associated with the first agency in the certificate comprises at least one of:
a first tag indicating a geographical area at which the first agency is located,
a second tag indicating a mission of the first agency,
a third tag indicating organization information associated with the first agency,
a fourth tag indicating security level information associated with the first agency, or
a fifth tag indicating urgency level information associated with the first agency.

4. The method of claim 1, wherein the certificate further comprises information identifying the first agency, an Internet assigned number authority (IANA) assigned private enterprise number (PEN) identifying a provider of the fabric junction, and an association between the PEN and the one or more tags associated with the first agency.

5. The method of claim 1, wherein the channel creation request further comprises at least one of a textual name of the channel or a unique identifier of the channel.

6. The method of claim 5, wherein the channel creation request further comprises a crypto password associated with an encryption for the communications in the channel.

7. The method of claim 1, wherein the configuring the rules at the fabric junction comprises at least one of:
verifying, by the fabric management application, that at least one of the one or more tags associated with the first agency matches the allow tag of the channel; or
verifying, by the fabric management application, that none of the one or more tags associated with the first agency matches the deny tag of the channel.

8. The method of claim 1, wherein the at least one of the allow tag or the deny tag of the channel comprises an indication of at least one of a geographical area, a mission, an organization, a security level, or an urgency level.

9. The method of claim 1, further comprising:
receiving, by the fabric management application from the first agency, based on the notification of the published channel, a request to subscribe to the channel.

10. The method of claim 1, further comprising:
establishing, by the fabric junction, a connection with the first agency based on a verification of the one or more tags associated with the first agency against the at least one of the allow tag or the deny tag of the channel of the second agency.

11. The method of claim 1, wherein the routing the communications comprises:
receiving, by the fabric junction from one of the first agency or the second agency in the channel, a first communication comprising textual data;
converting, by a text-to-speech engine at the fabric junction, the textual data to voice data; and
transmitting, by the fabric junction to the other one of the first agency or the second agency in the channel, a second communication comprising the voice data.

12. The method of claim 1, wherein the routing the communications comprises:
receiving, by the fabric junction from one of the first agency or the second agency in the channel, a first communication comprising voice data;
converting, by a speech-to-text engine at the fabric junction, the voice data to textual data; and
transmitting, by the fabric junction to the other one of the first agency or the second agency in the channel, a second communication comprising the textual data.

13. The method of claim 1, wherein the routing the communications comprises:
receiving, by the fabric junction from one of the first agency or the second agency in the channel, a first communication comprising voice data in a first language;
translating, by a speech translation engine at the fabric junction, the voice data from the first language to a second language; and
transmitting, by the fabric junction to the other one of the first agency or the second agency in the channel, a second communication comprising the translated voice data.

14. A method implemented in an inter-agency communication system to provide secured inter-agency communication with a directory service, wherein the method comprises:
issuing, by a fabric management application at a computing system associated with a communication fabric, a plurality of certificates, each to one of a plurality of agencies trusted for inter-agency communications over the communication fabric, wherein each of the plurality of certificates comprises one or more tags indicating one or more respective attributes associated with a channel accessibility of a respective one of the plurality of agencies in the communication fabric;
providing, by the fabric management application via a user interface at the computing system, a directory service listing the plurality of agencies and associated channels in a directory, wherein each channel of the channels is configured with at least one of:
an allow tag indicating an attribute of an agency allowed to access the respective channel; or
a deny tag indicating an attribute of an agency prohibited from accessing the respective channel;
filtering, by the fabric management application, the channels in the directory based on one or more tags associated with a first agency of the plurality of agencies in a respective one of the plurality of certificates and at least one of allow tags or deny tags of the channels;
receiving, by the fabric management application from the first agency, based on the filtering, a channel subscription request to subscribe to a first channel of the channels, wherein the first channel is associated with a second agency of the plurality of agencies;
configuring, by the fabric management application, based on the channel subscription request, a set of rules at a fabric junction of the communication fabric, wherein the fabric junction comprises a plurality of routing engines, and wherein the rules are based at least in part on:
at least one of an allow tag or a deny tag of the first channel, and
the one or more tags associated with the first agency; and
routing, by the fabric junction, based on the rules, communications over the first channel between the first agency and the second agency.

15. The method of claim 14, wherein a second channel of the channels is configured with at least one of:
a first channel access rule allowing an agency to access the second channel based on a serial number of a certificate to which the respective agency is issued,
a second channel access rule denying an agency to access the second channel based on a serial number of a certificate to which the respective agency is issued,
a third channel access rule allowing an agency to access the second channel based on information associated with an issuer of a certificate to which the respective agency is issued, or
a fourth channel access rule denying an agency to access the second channel based on information associated with an issuer of a certificate to which the respective agency is issued.

16. The method of claim 14, further comprising:
receiving, by the fabric junction from a third agency of the plurality of agencies, a query;
processing, by a machine learning engine at the fabric junction, the query and at least one or more tags associated with a channel accessibility of the third agency in a respective one of the plurality of certificates to output an indication of a fourth agency of the plurality of agencies;
transmitting, by the fabric junction to the fourth agency, the query;
receiving, by the fabric junction from the fourth agency in response to the query, a response; and
transmitting, by the fabric junction to the third agency, the response.

17. The method of claim 12, further comprising:
receiving, by the fabric junction from one of the first agency or the second agency, an archival request to archive the communications over the channel; and
archiving, based on the archival request, the communications over the channel at a memory.

18. A method implemented in an inter-agency communication system to provide secured inter-agency communications with management assistance, wherein the method comprises:
transmitting, by a management assistant application at a computing system of a first agency, to a fabric hub of an inter-agency communication fabric, a connection request;
receiving, by the management assistant application from the fabric hub, based on the connection request, a certificate that establishes a trusted relationship between the first agency and the inter-agency communication fabric, wherein the certificate comprises one or more tags indicating one or more respective attributes associated with a channel accessibility of the first agency in the inter-agency communication fabric;
receiving, by the management assistant application from the fabric hub, a notification of a published channel associated with a second agency, wherein the notification is based on:
the one or more tags of the first agency, and
at least one of an allow tag or a deny tag of the channel indicating respectively an attribute of an agency allowed to access the channel or an attribute of an agency prohibited from accessing the channel;
transmitting, by the management assistant application to the fabric hub, based on the notification of the published channel, a subscription request to subscribe to the channel; and
establishing, by the management assistant application with a fabric junction of the inter-agency communication fabric, a connection for communicating with the second agency over the channel.

19. The method of claim 18, wherein:
the notification of the published channel comprises an indication of a crypto password associated with an encryption for communications over the channel, and
the method further comprises:
configuring, by the management assistant application, one or more components at the first agency with the crypto password.

20. The method of claim 18, further comprising:
transmitting, by the management assistant application to the fabric hub, based on an automatic channel creation rule, a channel creation request to create a second channel for communications with a third agency.
